(19) United States
(12) Patent Application Publication
(10) Pub. No.: US 2026/0326084 A1
(43) Pub. Date: Oct. 22, 2026

(54) N-ALKYL-D-GLUCAMINE BASED MACROPOROUS POLYMERIC CRYOGEL FOR SEQUESTERING AND/OR REMOVING TOXIC CONTAMINANTS AND PROCESS OF MAKING THEREOF

(71) Applicant: EUREKA! TT SRL, Milano (IT)

(72) Inventors: Sabrina Carola CARROCCIO, Catania (IT); Francesca CUNSOLO, San Gregorio di Catania (IT); Sandro DATTILO, Catania (IT); Tommaso MECCA, Trecastagni (IT); Andrea Antonino SCAMPORRINO, Catania (IT)

(21) Appl. No.: 19/483,712

(22) PCT Filed: May 14, 2024
(86) PCT No.: PCT/EP2024/063147

§ 371 Date: Nov. 12, 2025

(30) Foreign Application Priority Data
May 17, 2023 (IT) 102023000009954

(51) Int. Cl. B01J 20/26; B01D 15/08; B01J 20/28; B01J 20/30; B09C 1/08; C02F 1/28; C02F 101/10; C02F 101/22; C08F 20/36; C08J 3/24

(52) U.S. Cl. CPC B01J 20/267; B01D 15/08; B01J 20/262; B01J 20/28047; B01J 20/28085; B01J 20/3071; B01J 20/3085; B09C 1/08; C02F 1/285; C08F 20/36; C08J 3/247; C02F 2101/103; C02F 2101/22

(57) ABSTRACT

An improved N-alkyl-D-glucamine based macroporous polymeric cryogel, and the process for its preparation which avoids any purification processes of reactants, and its use for sequestering and/or removing toxic contaminants from water and/or soil, is disclosed.

The present invention refers to the field of chemistry and, in particular, to a new N-alkyl-D-glucamine based macroporous polymeric cryogel, and the improved process for the preparation thereof, to be used for sequestering and/or removing toxic contaminants such as metalloids and/or toxic heavy metals, oxoanions, and negatively charged organic species, for example from water and/or soil.

### PRIOR ART

International patent application WO2019/131629 discloses a metal adsorbing agent for removing metal impurities in a solution containing a chelating agent [A] and a chelating agent [B], wherein [A] is metal adsorbing agent with a carrier that includes a glucamine type functional group, and [B] is a metal adsorbing agent including a specified variety of functional groups, and where both carriers of the chelating agents [A] and [B] are silica containing substances, or polystyrene or crosslinked porous polystyrene, and the solution contains water or an organic solvent. The application claims also a method for removing metal impurities in solution.

European patent EP3359605 discloses some universal glucamine-based pigment dispersions containing: (A) at least one organic and/or inorganic pigment, (B) one or more dispersing agents and/or surfactants and (C) at least one of glucamine-family formula specifically designated by them.

Japanese patent JP7220904 discloses a whole series of glucamine derivatives for liquid/liquid extractions of metals in aqueous solutions.

US patent application US20200207644 discloses a method for removing SiO₂ in an absorption tower and the adsorbent element is anion exchange resin with a glucamine group.

US patent application US20220096978 discloses a production method for an organic solvent that uses a cartridge filter; in their filter there are alternating A and B nonwoven layers, A is with polyolefins and sulfonate groups and B is polyolefins and a group between amines, etc and N-methyl-d-glucamine.

US patent applications US20220410084 and US2020254398 disclose filter materials and method for reducing metals. In these patent applications, a material for filters with poly-OH binder such as N-methyl-glucamine and/or polyphosphoric acid ligand, which are highly effective in metal ion capture, is claimed.

International patent application WO2020127237 discloses a family of glucamine-based surfactants.

None of the documents cited above mentions a process to produce N-alkyl-D-glucamine based macroporous polymeric cryogel for sequestering and/or removing toxic contaminants.

International patent application WO2021013596 of the same inventors discloses N-alkyl-D-glucamine based macroporous polymeric cryogels with three-dimensional structure and with interconnected pores, which are used in an efficient way for sequestering and/or removing toxic contaminants, such as toxic metalloids and/or toxic heavy metals, for example from water and/or soil and a method for the preparation of said N-alkyl-D-glucamine based macroporous polymeric cryogels.

The process disclosed in WO2021013596 for the preparation of the monomer presents however some inconveniences (long reaction time, use of methanol as reaction solvent, which has to be removed at the end of the process under low temperature by evaporation or distillation, a purification procedure of the so obtained monomer) which can make this protocol difficult or costly to use on an industrial scale.

The inventors unexpectedly found that N-alkyl-D-glucamine based macroporous polymeric cryogels as disclosed in WO2021013596 could be improved by choosing specific crosslinkers being a N,N-disubstituted-N-alkyl-D-glucammonium salt. Said compounds show improved complexation in the contaminants sequestration processes.

The inventors also modified and implemented the process for the production of N-alkyl-D-glucamine based macroporous polymeric cryogels as disclosed in WO2021013596, wherein the new process avoids purification processes of reactants, implies relevant benefits in terms of sustainability and productivity.

The functionalization of a polymerizable monomer with N-alkyl-D-glucamine was in fact performed by using water as the only solvent or a mixture of water and a low amount of an immiscible organic solvent, that has a density lower than water. This new procedure implies significant advantages such as reduction of the reaction time to less than 24 hours if compared to the time-consuming synthesis reported in WO2021013596 where 7 days were needed to reach elevated yield; the simultaneous production and recovery of both monomer and the crosslinking agent, i.e. N,N-disubstituted-N-alkyl-D-glucammonium salt, in the same reaction phase, that is at the bottom of the reaction mixture, so that only a dilution and a pH control have to be performed before the addition of initiators for the production of cryogel; a purification step after monomer production is not required; the aqueous phase containing unreacted N-alkyl-D-glucamine and a small amount of N-substituted-N-alkyl D-glucamine and N,N-disubstituted-N-alkyl-D-glucammonium salt may be recycled in a following process as well as the immiscible organic solvent, that has a density lower than water.

### OBJECT OF THE INVENTION

Object of the present invention is a macroporous polymeric adsorbent material having a three-dimensional structure with interconnected pores of diameter comprised between 5 and 100 μm measured by scanning electron microscopy (SEM), being in the form of a cryogel, wherein the cryogel is of formula (I):

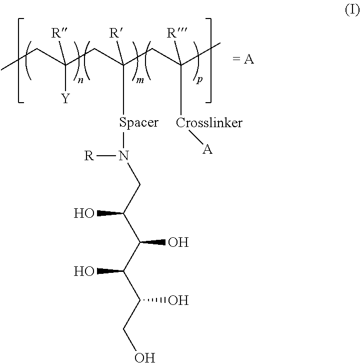

wherein n is a percentage comprised between 0 and 99;
m is a percentage comprised between 1 and 100;
n+m is 100;
p is a value ranging from 0% to 300% of (n+m);
Y is a moiety of a monomer that does not contain N-alkyl-D-glucamine and is selected from the group consisting of: COOH, CONH₂, COOCH₂CH₂OH, COOCH₂CH₂NH₂, COOCH₂CH₂N(CH₃)₂, SO₃H, alkyl or aryl residue containing a SO₃H group or a COOH group;
R is selected from the group consisting of CH₃, CH₂CH₃, CH₂CH₂CH₃, CH(CH₃)₂;
R′, R″, R″′, the same or different are H or CH₃;
Spacer is the moiety of the monomer containing N-alkyl-D-glucamine which connects the N-alkyl-D-glucamine with the main polymeric chain, and is selected from the group consisting of:

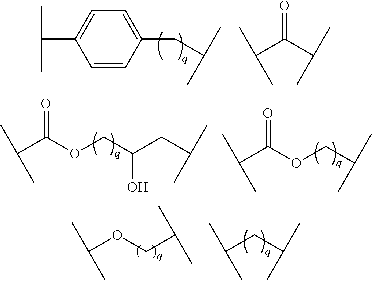

q is an integer comprised between 1 and 10;
[symbol] represents the main polymeric chain;
[symbol] represents the link with the nitrogen of N-alkyl-D-glucamine;

A is the main polymeric chain which is repeated as indicated in the general formula (I);

Crosslinker is a N,N-disubstituted-N-alkyl-D-glucammonium salt, wherein disubstituted means substituted with two polymerizable moieties, equal or different, selected from the group consisting of acrylic, methacrylic, vinylic, styrenic, vinylbenzylic, and alkyl means C1-C4 alkyl or

a mixture of N,N-disubstituted-N-alkyl-D-glucammonium salt with another crosslinker, not being and different from N,N-disubstituted-N-alkyl-D-glucammonium salt, selected from group consisting of: N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, poly(propyleneglycol)diacrylate.

Another object of the present invention is a new sustainable process for the preparation of a macroporous polymeric adsorbent material having a three-dimensional structure with interconnected pores of diameter comprised between 5 and 100 μm measured by scanning electron microscopy (SEM), being in the form of a cryogel, wherein the cryogel is of formula (I):

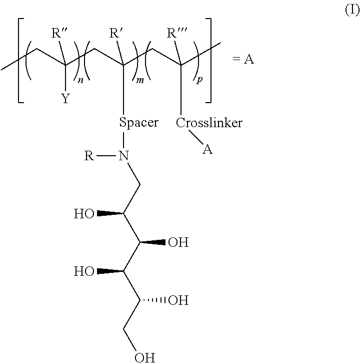

wherein n is a percentage comprised between 0 and 99;
m is a percentage comprised between 1 and 100;
n+m is 100;
p is a value ranging from 0% to 300% of (n+m);
Y is a moiety of a monomer that does not contain N-alkyl-D-glucamine and is selected from the group consisting of: COOH, CONH₂, COOCH₂CH₂OH, COOCH₂CH₂NH₂, COOCH₂CH₂N(CH₃)₂, SO₃H, alkyl or aryl residue containing a SO₃H group or a COOH group;
R is selected from the group consisting of CH₃, CH₂CH₃, CH₂CH₂CH₃, CH(CH₃)₂;
R′, R″, R″′, the same or different are H or CH₃;
Spacer is the moiety of the monomer containing N-alkyl-D-glucamine which connects the N-alkyl-D-glucamine with the main polymeric chain, and is selected from the group consisting of:

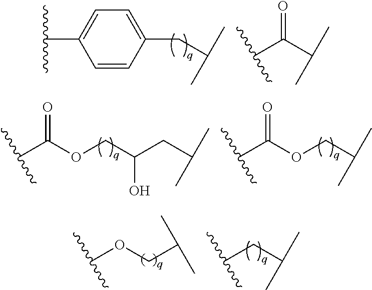

q is an integer comprised between 1 and 10;
[symbol] represents the main polymeric chain;
[symbol] represents the link with the nitrogen of N-alkyl-D-glucamine; A is the main polymeric chain which is repeated as indicated in the general formula (I); Crosslinker is a N,N-disubstituted-N-alkyl-D-glucammonium salt, wherein disubstituted means substituted with two polymerizable moieties, equal or different, selected from the group consisting of acrylic, methacrylic, vinylic, styrenic, vinylbenzylic, and alkyl means C1-C4 alkyl or
a mixture of N,N-disubstituted-N-alkyl-D-glucammonium salt with another crosslinker, not being and different from N,N-disubstituted-N-alkyl-D-glucammonium salt, selected from group consisting of: N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, poly(propyleneglycol)diacrylate
wherein the process starts with the co-production of a monomer containing N-substituted-N-alkyl-D-glucamine and the crosslinker being a N,N-disubstituted-N-alkyl-D-glucammonium salt, in water or in a water and an organic solvent being immiscible in water and having a density lower than water, to obtain a mixture of the monomer and the crosslinker, which is used without any purification step for the preparation of cryogels by dilution in water at a pH comprised between 6-8,
and optionally a monomer that not contains N-substituted-N-alkyl-D-glucamine and/or a crosslinker not being and different from N,N-disubstituted-N-alkyl-D-glucammonium salt are added,
followed by the addition under stirring at a temperature comprised between 0 and 5° C. of an initiator of radical polymerization and a catalyst for the production of radicals to obtain a solution, wherein said obtained solution is then maintained at a temperature comprised between −10 and −25° C. for a time comprised between 12 and 72 hours until the cryogel is obtained, and finally the cryogel is thawed, washed and optionally dried.

It is another object of the present invention the use of a macroporous polymeric adsorbent material having a three-dimensional structure with interconnected pores of diameter comprised between 5 and 100 μm, being in the form of a cryogel, wherein the cryogel is of formula (I), also as obtained by the process of the present invention, for sequestering and/or removing toxic contaminants from contaminated water or soil.

### BRIEF DESCRIPTION OF DRAWINGS

FIG. 1 shows the 1H NMR spectrum of the mixture monomer/crosslinker obtained in the bottom reaction phase of the monomer synthesis.

FIG. 2 shows the scanning electron micrography of the material.

FIG. 3 shows the thermal gravimetrical analysis of the material performed in nitrogen flow from 50 to 800° c. at 10° c./min.

### DETAILED DESCRIPTION OF THE INVENTION

Within the meaning of the present invention, macroporous means a material containing pores with diameters bigger than 50 nm, according to IUPAC recommendations.

Within the meaning of the present invention, adsorbent material means a material able to remove, by chemical or physical phenomena occurring at the interface, some chemical species from a solution, in particular case from a water solution.

Within the meaning of the present invention, cryo-polymerization means the process of obtaining macroporous polymers by performing a polymerization at temperature below the freezing point of the solvent used to solubilize the monomers.

Within the meaning of the present invention cryogel means a polymeric matrix obtained by cryo-polymerization.

Within the meaning of the present invention HEMA means monomer of 2-hydroxyethyl methacrylate.

Within the meaning of the present invention MBAA means methylene-bisacrylamide.

Within the meaning of the present invention polystyrene-N-methyl-D-glucamine means a polymer obtained from the polymerization of N-(4-vinylbenzyl)-N-methyl-D-glucamine monomer and a crosslinking agent.

Within the meaning of the present invention, oxyanions are negatively charged oxygenated ions, such as phosphate, sulphate, chromate, arsenate, borate, molybdate, vanadate.

Within the meaning of the present invention Negatively charged organic contaminants means toxic negatively charged organic compounds such as pesticide 2,4-D or anti-inflammatory drug Piroxicam.

Within the meaning of the present invention toxic contaminant means toxic metalloids and/or toxic heavy metals, and/or toxic oxyanions.

Within the meaning of the present invention a metalloid is a chemical element having properties in between those of metals and non-metals.

Within the meaning of the present invention toxic metalloids as such or the corresponding oxyanions are arsenic, boron, antimony.

Within the meaning of the present invention heavy metal is a metal with high density, high atomic weight or high atomic numbers.

Within the meaning of the present invention toxic heavy metals are selected from the group consisting of cadmium, mercury, lead, manganese, chromium, cobalt, nickel, copper, zinc, silver, thallium, molybdenum, vanadium, as such or the corresponding oxyanions. More preferably, toxic heavy metal as such or the corresponding oxyanion is chromium, molybdenum, vanadium.

The main object of the present invention is a macroporous polymeric adsorbent material having a three-dimensional structure with interconnected pores of diameter comprised between 5 and 100 μm measured by scanning electron microscopy (SEM), being in the form of a cryogel, wherein the cryogel is of formula (I):

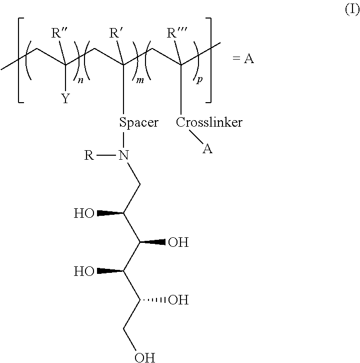

wherein n is a percentage comprised between 0 and 99;
m is a percentage comprised between 1 and 100;
n+m is 100;
p is a value ranging from 0% to 300% of (n+m);
Y is a moiety of a monomer that does not contain N-alkyl-D-glucamine and is selected from the group consisting of: COOH, CONH₂, COOCH₂CH₂OH, COOCH₂CH₂NH₂, COOCH₂CH₂N(CH₃)₂, SO₃H, alkyl or aryl residue containing a SO₃H group or a COOH group;
R is selected from the group consisting of CH₃, CH₂CH₃, CH₂CH₂CH₃, CH(CH₃)₂;
R′, R″, R″′, the same or different are H or CH₃;
Spacer is the moiety of the monomer containing N-alkyl-D-glucamine which connects the N-alkyl-D-glucamine with the main polymeric chain, and is selected from the group consisting of:

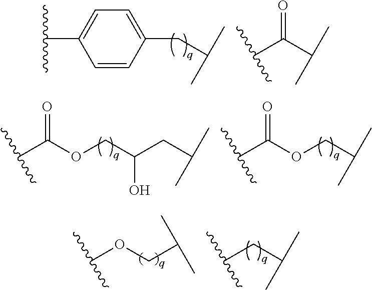

q is an integer comprised between 1 and 10;
[symbol] represents the main polymeric chain;
[symbol] represents the link with the nitrogen of N-alkyl-D-glucamine;
A is the main polymeric chain which is repeated as indicated in the general formula (I);
Crosslinker is a N,N-disubstituted-N-alkyl-D-glucammonium salt, wherein disubstituted means substituted with two polymerizable moieties, equal or different, selected from the group consisting of acrylic, methacrylic, vinylic, styrenic, vinylbenzylic, and alkyl means C1-C4 alkyl or
a mixture of N,N-disubstituted-N-alkyl-D-glucammonium salt with another crosslinker, not being and different from N,N-disubstituted-N-alkyl-D-glucammonium salt, selected from group consisting of: N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, poly(propyleneglycol)diacrylate.

It is also object of the present invention a process for the preparation of a macroporous polymeric adsorbent material having a three-dimensional structure with interconnected pores of diameter comprised between 5 and 100 μm measured by scanning electron microscopy (SEM), being in the form of a cryogel, wherein the cryogel is of formula (I):

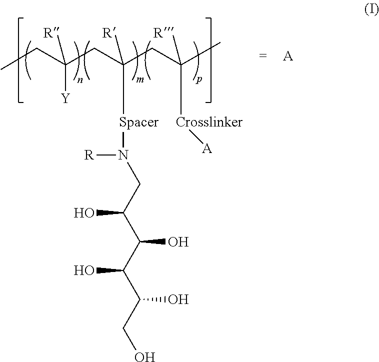

wherein n is a percentage comprised between 0 and 99;
m is a percentage comprised between 1 and 100;
n+m is 100;
p is a value ranging from 0% to 300% of (n+m);
Y is a moiety of a monomer that does not contain N-alkyl-D-glucamine and is selected from the group consisting of: COOH, CONH₂, COOCH₂CH₂OH, COOCH₂CH₂NH₂, COOCH₂CH₂N(CH₃)₂, SO₃H, alkyl or aryl residue containing a SO₃H group or a COOH group;
R is selected from the group consisting of CH₃, CH₂CH₃, CH₂CH₂CH₃, CH(CH₃)₂;
R′, R″, R″′, the same or different are H or CH₃;
Spacer is the moiety of the monomer containing N-alkyl-D-glucamine which connects the N-alkyl-D-glucamine with the main polymeric chain, and is selected from the group consisting of:

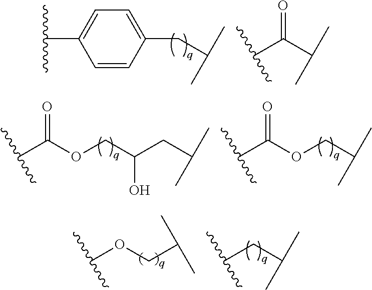

q is an integer comprised between 1 and 10;
[symbol] represents the main polymeric chain;
[symbol] represents the link with the nitrogen of N-alkyl-D-glucamine;
A is the main polymeric chain which is repeated as indicated in the general formula (I);
Crosslinker is a N,N-disubstituted-N-alkyl-D-glucammonium salt, wherein disubstituted means substituted with two polymerizable moieties, equal or different, selected from the group consisting of acrylic, methacrylic, vinylic, styrenic, vinylbenzylic, and alkyl means C1-C4 alkyl or
a mixture of N,N-disubstituted-N-alkyl-D-glucammonium salt with another crosslinker, not being and different from N,N-disubstituted-N-alkyl-D-glucammonium salt, selected from group consisting of: N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, poly(propyleneglycol)diacrylate,
wherein the process starts with the co-production of a monomer containing N-substituted-N-alkyl-D-glucamine and the crosslinker being a N,N-disubstituted-N-alkyl-D-glucammonium salt, in water or in a water and an organic solvent being immiscible in water and having a density lower than water, to obtain a mixture of the monomer and the crosslinker, which is used without any purification step for the preparation of cryogels by dilution in water at a pH comprised between 6-8,
optionally a monomer that not contains N-substituted-N-alkyl-D-glucamine and/or a crosslinker not being and different from N,N-disubstituted-N-alkyl-D-glucammonium salt are added,
followed by the addition under stirring at a temperature comprised between 0 and 5° C. of an initiator of radical polymerization and a catalyst for the production of radicals to obtain a solution, wherein said obtained solution is then maintained at a temperature comprised between −10 and −25° C. for a time comprised between 12 and 72 hours until the cryogel is obtained, and finally the cryogel is thawed, washed and optionally dried.

Preferably the process for the preparation of a macroporous polymeric adsorbent material having a three-dimensional structure with interconnected pores of diameter comprised between 5 and 100 μm measured by scanning electron microscopy (SEM), being in the form of a cryogel, wherein the cryogel is of formula (I):

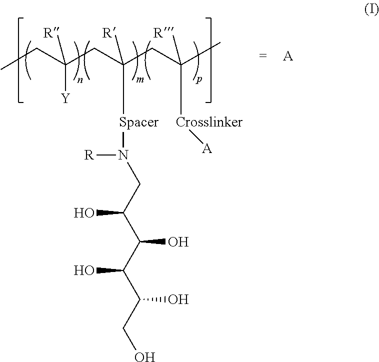

wherein n is a percentage comprised between 0 and 99;
m is a percentage comprised between 1 and 100;
n+m is 100;
p is a value ranging from 0% to 300% of (n+m);
Y is a moiety of a monomer that does not contain N-alkyl-D-glucamine and is selected from the group consisting of: COOH, CONH₂, COOCH₂CH₂OH, COOCH₂CH₂NH₂, COOCH₂CH₂N(CH₃)₂, SO₃H, alkyl or aryl residue containing a SO₃H group or a COOH group;
R is selected from the group consisting of CH₃, CH₂CH₃, CH₂CH₂CH₃, CH(CH₃)₂;
R′, R″, R″′, the same or different are H or CH₃;
Spacer is the moiety of the monomer containing N-alkyl-D-glucamine which connects the N-alkyl-D-glucamine with the main polymeric chain, and is selected from the group consisting of:

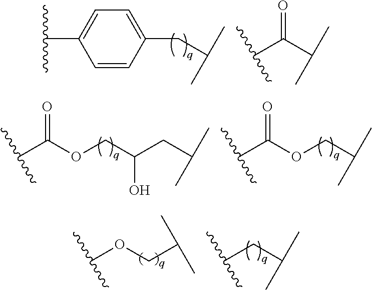

q is an integer comprised between 1 and 10;
[symbol] represents the main polymeric chain;
[symbol] represents the link with the nitrogen of N-alkyl-D-glucamine;
A is the main polymeric chain which is repeated as indicated in the general formula (I); Crosslinker is a N,N-disubstituted-N-alkyl-D-glucammonium salt, wherein disubstituted means substituted with two polymerizable moieties, equal or different, selected from the group consisting of acrylic, methacrylic, vinylic, styrenic, vinylbenzylic, and alkyl means C1-C4 alkyl or
a mixture of N,N-disubstituted-N-alkyl-D-glucammonium salt with another crosslinker, not being and different from N,N-disubstituted-N-alkyl-D-glucammonium salt, selected from group consisting of: N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, poly(propyleneglycol)diacrylate
comprises the following steps:
   a) mixing in water or in a mixture comprising water and a suitable organic solvent, immiscible with water and having a density lower than water, in the presence of a salt of carbonic acid, at a temperature comprised between 15° C. and 60° C. and for a time comprised between 2 hours and 72 hours, N-alkyl-D-glucamine with the appropriate unsaturated alkyl halide or acyl halide, for the synthesis of at least one polymerizable monomer containing N-substituted-N-alkyl-D-glucamine selected from the group consisting of:

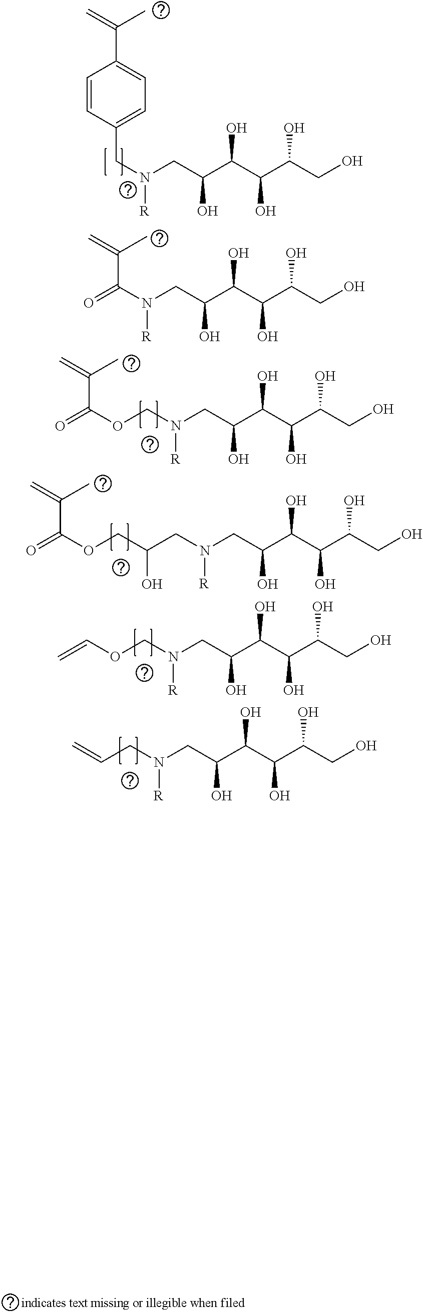

and the corresponding N,N-disubstituted-N-alkyl-D-glucammonium salt acting as a crosslinker;
wherein R is selected from the group consisting of CH₃, CH₂CH₃, CH₂CH₂CH₃, CH(CH₃)₂;
R′ is H, CH₃;
q is an integer comprised between 1 and 10.
b) Isolation of the bottom phase of the reaction mixture of the step a) obtained at the end of the reaction;
c) The bottom phase of the step b) is diluted with water and pH adjusted in an interval comprised between 6-8 under stirring at a temperature between 0 and 5° C., then a solution containing an initiator of radical polymerization and a catalyst for the production of radicals is added to obtain a mixture;
d) Cooling of the mixture as obtained at the end of step c) at a temperature preferably comprised between −10 and −25° C. for a time comprised between 12 and 48 hours until the cryogel is obtained;
e) The cryogel is then thawed, washed, and optionally dried.

Optionally, after step b) and before steps c) a further step c′) is added wherein in step c′) to the bottom phase, as obtained at the step b), a monomer that not contains N-substituted-N-alkyl-D-glucamine and/or a crosslinker not being and different from N,N-disubstituted-N-alkyl-D-glucammonium salt are added.

Another object of the present invention is the macroporous polymeric adsorbent material having a three-dimensional structure with interconnected pores of diameter comprised between 5 and 100 μm, being in the form of a cryogel measured by scanning electron microscopy (SEM), wherein the cryogel is of formula (I):

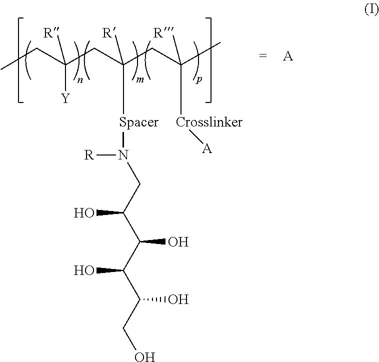

wherein n is a percentage comprised between 0 and 99;
m is a percentage comprised between 1 and 100;
n+m is 100;
p is a value ranging from 0% to 300% of (n+m);
Y is a moiety of a monomer that does not contain N-alkyl-D-glucamine and is selected from the group consisting of: COOH, CONH₂, COOCH₂CH₂OH, COOCH₂CH₂NH₂, COOCH₂CH₂N(CH₃)₂, SO₃H, alkyl or aryl residue containing a SO₃H group or a COOH group;
R is selected from the group consisting of CH₃, CH₂CH₃, CH₂CH₂CH₃, CH(CH₃)₂;
R′, R″, R″′, the same or different are H or CH₃; Spacer is the moiety of the monomer containing N-alkyl-D-glucamine which connects the N-alkyl-D-glucamine with the main polymeric chain, and is selected from the group consisting of:

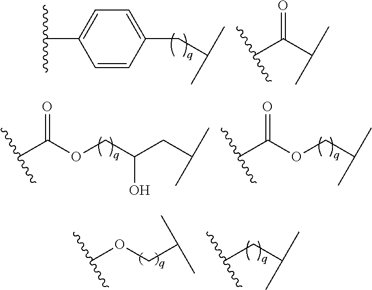

q is an integer comprised between 1 and 10;
[symbol] represents the main polymeric chain;
[symbol] represents the link with the nitrogen of N-alkyl-D-glucamine;
A is the main polymeric chain which is repeated as indicated in the general formula (I);
Crosslinker is a N,N-disubstituted-N-alkyl-D-glucammonium salt, wherein disubstituted means substituted with two polymerizable moieties, equal or different, selected from the group consisting of acrylic, methacrylic, vinylic, styrenic, vinylbenzylic, and alkyl means C1-C4 alkyl or
a mixture of N,N-disubstituted-N-alkyl-D-glucammonium salt with another crosslinker, not being and different from N,N-disubstituted-N-alkyl-D-glucammonium salt, selected from group consisting of: N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, poly(propyleneglycol)diacrylate,
obtained by a process starting with the co-production of a monomer containing N-substituted-N-alkyl-D-glucamine and the crosslinker being a N,N-disubstituted-N-alkyl-D-glucammonium salt, in water or in a water and an organic solvent being immiscible in water and having a density lower than water, to obtain a mixture of the monomer and the crosslinker, which is used without any purification step for the preparation of cryogels by dilution in water at a pH comprised between 6-8,
optionally a monomer not containing N-alkyl-D-glucamine and/or a crosslinker not being and different from N,N-disubstituted-N-alkyl-D-glucammonium salt are added,
followed by the addition under stirring at a temperature comprised between 0 and 5° C. of an initiator of radical polymerization and a catalyst for the production of radicals to obtain a solution, wherein said obtained solution is then maintained at a temperature comprised between −10 and −25° C. for a time comprised between 12 and 72 hours until the cryogel is obtained, and finally the cryogel is thawed, washed and optionally dried.

Preferably the monomer not containing N-substituted-N-alkyl-D-glucamine is selected from the group consisting of:

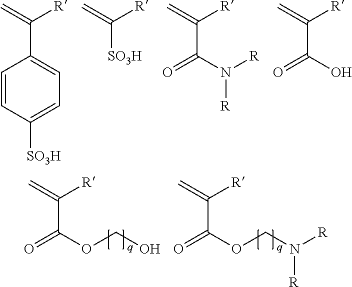

wherein T is H, C1-C4 alkyl;
Z is H, CH₃;
q is an integer comprised between 1 and 10;

Preferably the crosslinker not being and different from N,N-disubstituted-N-alkyl-D-glucammonium salt is selected from group consisting of: N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, poly(propyleneglycol)diacrylate.

Preferably the N,N-disubstituted-N-alkyl-D-glucammonium salt crosslinker is selected from the group consisting of:

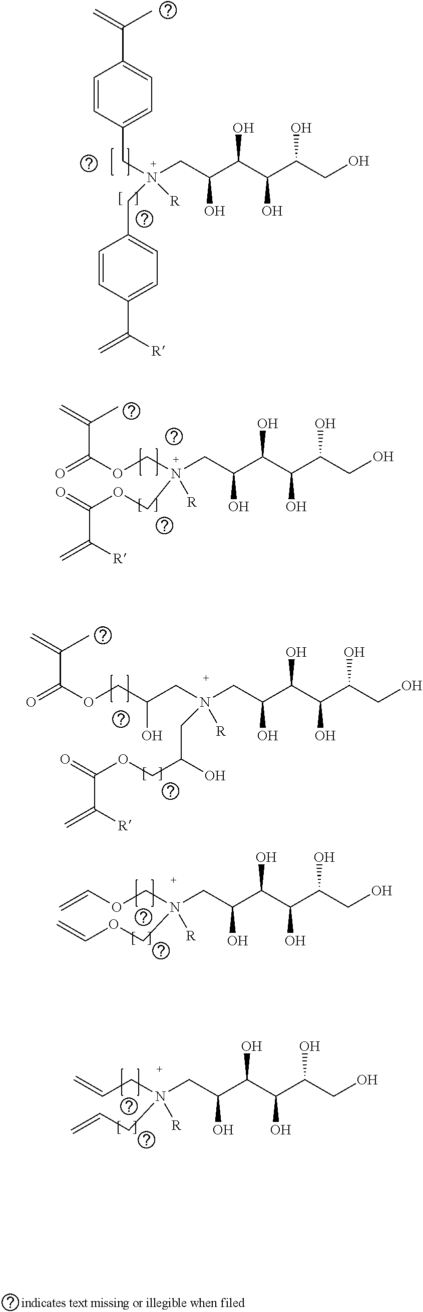

wherein R is selected from the group consisting of CH₃, CH₂CH₃, CH₂CH₂CH₃, CH(CH₃)₂;
R′ is H, CH₃;
q is an integer comprised between 1 and 10.

Most preferably the N,N-disubstituted-N-alkyl-D-glucammonium salt cross linker is N,N-bis(4-vinylbenzyl)-N-methyl-D-glucammonium chloride.

Preferably p is a value ranging from 50% to 200% of (n+m); Preferably the alkyl halide used in step a) is 4-Vinylbenzyl chloride; Preferably the crosslinker is produced simultaneously with the production of the monomer N-(4-vinylbenzyl)-N-alkyl-D-glucamine; Preferably, the organic solvent immiscible in water and with a lower density than water is selected from the group consisting of: linear, cyclic or ramified C6-C20 hydrocarbons, esters of carboxylic acids C5-C22, ethers C4-C20, vegetable oils, hydrogenated vegetable oils.

Preferably, the volume % of this organic solvent is comprised between 0%-100% referred to the volume of water.

Preferably N-methyl-D-glucamine is dissolved in water in a concentration range of 0.2 M-5.0 M.

Preferably the salt of carbonic acid is sodium carbonate or potassium carbonate.

Preferably, the molar ratio between 4-Vinylbenzyl chloride and N-methyl-D-glucamine is comprised between 2/1 and ⅕.

Preferably, 4-Vinylbenzil chloride is diluted in an organic solvent immiscible with water and with a lower density than water, in a concentration range of 0.2 M-15.0 M.

Preferably, the aqueous phase contains residue of unreacted N-methyl-D-glucamine with a minor amount of the N-monosubstituted and N,N-disubstituted (4-vinylbenzyl)-N-methyl-D-glucamine wherein said aqueous phase can be used as such for new preparations.

Preferably, if 4-Vinylbenzyl chloride is diluted in an organic solvent immiscible in water and with a lower density than water an additional upper phase is formed wherein said additional upper phase contains residues of unreacted 4-vinylbenzyl chloride and can be recovered and used for further reactions.

Preferably the molar amount of polymerizable monomer not containing N-alkyl-D-glucamine in step c′) is comprised between 0% to 99%, more preferably is from 0% to 50% of the total amount of all polymerizable species present in the reaction mixture.

Preferably the molar amount of crosslinker not being and different from N,N-disubstituted-N-alkyl-D-glucammonium salt added in step c′) is comprised between 0% to 40%, more preferably is from 0% to 30% of the total amount of all polymerizable species present in the reaction mixture.

Preferably the total amount of all polymerizable species present in the reaction mixture in step c) is comprised between 5% and 50% in weight in respect to the volume of water, more preferably between 10% and 30%.

Preferably in step c) the pH is neutralized with a suitable acidic solution at a temperature preferably comprised between 0 and 5° C.

Preferably pH in step c) is maintained neutral, preferably in the range between 6-8.

Preferably the initiator of radical polymerization is selected from the group consisting of organic and inorganic peroxides, peracids, azo-compounds, redox or UV initiators.

Preferably the initiator of radical polymerization is in a concentration between 0.5% and 10% by weight, based on the sum of monomers by weight.

Preferably the catalyst for the production of radicals is tetramethylethylenediamine.

Preferably the mixture of step c) is cooled to 0° C. then 10% w/v ammonium persulphate (APS) solution in water and 10% w/v tetramethyl-ethylene-diamine (TEMED) solution in water are added under vigorous stirring.

Preferably the amount of APS and TEMED is comprised between 1/2000 w/v and 1/200 w/v of the final solution.

Preferably the mixture is stirred for about 1-3 min.

Preferably in step e) washing is carried out with water, followed by diluted HCl and finally with mixtures of H2O/HCl/alcohol wherein the concentration of alcohol progressively increases up to pure alcohol.

Preferably the alcohol used in the washing step is selected from the group consisting of: methanol, ethanol, propanol, 2-propanol, and butanol.

Preferably drying is carried out under nitrogen or dry air flow and then under vacuum.

In a preferred embodiment in step a) to obtain a N-methyl-D-glucamine based monomer and the corresponding disubstituted cross-linker, 4-vinylbenzyl chloride, neat or diluted in a suitable organic solvent immiscible in water and with a lower density than water, is added to an aqueous solution containing N-methyl-D-glucamine and a salt of carbonic acid under stirring at a temperature comprised between 15° C. and 60° C. for a time comprised between 2 hours and 72 hours and preferably between 2 hours and 36 hours until the mixture separates in an emulsion comprising 2 or 3 phases where the bottom phase contains a mixture of N-(4-vinyl-benzyl)-N-methyl-D-glucamine and N,N-bis(4-vinylbenzyl)-N-methyl-D-glucammonium chloride. The amount of N,N-bis(4-vinylbenzyl)-N-methyl-D-glucammonium chloride is comprised between 30% and 300%, preferably between 50% and 200% referred to N-(4-vinylbenzyl)-N-methyl-D-glucamine. Optionally a small amount of a radical inhibitor is added to this bottom phase.

The cryogel as obtained by the process of the present invention is used for sequestering and/or removing toxic contaminants.

Preferably the cryogel as obtained by the process of the present invention is used for sequestering and/or removing toxic contaminants from contaminated water.

Preferably the cryogel as obtained by the process of the present invention is used for sequestering and/or removing toxic contaminants from contaminated soil.

Preferably toxic contaminants are oxyanions that are negatively charged oxygenated ions, such as phosphate, sulphate, chromate, arsenate, borate, molybdate, vanadate.

Preferably toxic contaminants are toxic metalloids and/or toxic heavy metals.

Preferably toxic metalloids are selected from the group consisting of arsenic, boron, antimony. More preferably boron, arsenic.

Preferably toxic heavy metals are selected from the group consisting of cadmium, mercury, lead, manganese, chromium, cobalt, nickel, copper, zinc, silver, thallium, molybdenum, vanadium. More preferably chromium, molybdenum, vanadium.

Preferably toxic contaminants are negatively charged organic contaminants such as pesticide 2,4-D or anti-inflammatory drug Piroxicam.

The cryogel as obtained by the process of the present invention can be used for the manufacture of devices for sequestering toxic contaminants.

The devices can be used in any process known in the art for sequestering toxic contaminants, preferably from water, such as filters which can be included in filtration system for domestic or industrial environments, can be included in water filtering cartridges for carafes, can be included in systems for remediation of sewage and wastewater.

Sponges are preferably used in soil remediation.

After remediation, the contaminants are retained by the sponge when it is squeezed while the liquid matrix is released clean.

As example of arsenic and chromium sequestration, solutions that contain these pollutants were tested in a static mode revealing excellent performance in terms of adsorption for all synthesized samples. The equilibrium sorption results, showed a startling aptitude for arsenic as well as chromium sorption properties if compared with similar polymeric materials. Excellent reusability by a simple squeezing of the sponge several times as well as recyclability after washing cycles were also proved.

The following Examples further illustrate the invention.

Example 1: synthesis of a polymerizable monomer containing N-methyl-D-glucamine and the corresponding N,N-disubstituted-N-methyl-D-glucammonium salt.

N-methyl-D-glucamine (132.6 g) was dissolved in 680 ml of H₂O, followed by Na₂CO₃H₂O (42.2 g). 4-Vinyl-benzylchloride (95.8 mL) was then added to the solution, the mixture was heated at 40° C. and vigorously stirred for 24 hours. The emulsion formed was then allowed to stand for 2 hours while the temperature reached T.A., two phases were then formed: the upper aqueous phase contains residue of unreacted glucamine with minor amounts of N-(4-vinylbenzyl)-N-methyl-D-glucamine (VbNMG) in mixture with N,N-bis(4-vinylbenzyl)-N-methyl-D-glucammonium chloride; the lower bottom phase contains the mixture of N-(4-vinylbenzyl)-N-methyl-D-glucamine (VbNMG) in mixture with N,N-bis(4-vinylbenzyl)-N-methyl-D-glucammonium chloride in a molar ratio of about 35/65, and it is ready to be utilized for the preparation of cryogels for sequestering and/or removing toxic contaminants.

Example 2: synthesis of a polymerizable monomer containing N-methyl-D-glucamine and the corresponding N,N-disubstituted-N-methyl-D-glucammonium salt using cyclohexane as organic solvent.

N-methyl-D-glucamine (132.6 g) was dissolved in 680 ml of H₂O, followed by Na₂CO₃H₂O (42.2 g). 4-Vinyl-benzylchloride (95.8 mL) was diluted with cyclohexane (306 mL) then added to the solution, the mixture was heated at 40° C. and vigorously stirred for 36 hours. The emulsion formed was then allowed to stand for 2 hours while the temperature reached T.A., three phases were then formed: the upper organic phase contains mainly cyclohexane with residues of unreacted 4-vinylbenzyl chloride; the central aqueous phase contains residue of unreacted glucamine with minor amounts of N-(4-vinylbenzyl)-N-methyl-D-glucamine (VbNMG) in mixture with N,N-bis(4-vinylbenzyl)-N-methyl-D-glucammonium chloride; the lower bottom phase contains the mixture of N-(4-vinylbenzyl)-N-methyl-D-glucamine (VbNMG) in mixture with N,N-bis(4-vinylbenzyl)-N-methyl-D-glucammonium chloride in a ratio of about 53/47, and it is ready to be utilized for the preparation of cryogels for sequestering and/or removing toxic contaminants.

Example 3: synthesis of a polymerizable monomer containing N-methyl-D-glucamine and the corresponding N,N-disubstituted-N-methyl-D-glucammonium salt using coconut oil as organic solvent.

N-methyl-D-glucamine (132.6 g) was dissolved in 680 ml of H₂O, followed by Na₂CO₃H₂O (42.2 g). 4-Vinyl-benzylchloride (95.8 mL) was diluted with coconut oil (306 mL) then added to the solution, the mixture was heated at 40° C. and vigorously stirred for 36 hours. The emulsion formed was then allowed to stand for 2 hours while the temperature reached T.A., three phases were then formed: the upper organic phase contains mainly coconut oil with residues of unreacted 4-vinyl benzyl chloride; the central aqueous phase contains residue of unreacted glucamine with minor amounts of N-(4-vinyl benzyl)-N-methyl-D-glucamine (VbNMG) in mixture with N,N-bis(4-vinylbenzyl)-N-methyl-D-glucammonium chloride; the lower bottom phase contains the mixture of N-(4-vinylbenzyl)-N-methyl-D-glucamine (VbNMG) in mixture with N,N-bis(4-vinylbenzyl)-N-methyl-D-glucammonium chloride in a ratio of about 52/48, and it is ready to be utilized for the preparation of cryogels for sequestering and/or removing toxic contaminants.

Example 4: synthesis of cryogel starting from the monomer synthesized with any of the procedure of examples 1, 2, 3.

The organic phase containing N-(4-vinylbenzyl)-N-methyl-D-glucamine (VbNMG) in a mixture with N,N-bis(4-vinylbenzyl)-N-methyl-D-glucammonium chloride (100 mL) was diluted in water (100 mL) and HCl 1.5M was added under stirring until pH was in the range 6-8. Water was then added to reach a final volume of solution of 242 mL. A small amount of a radical inhibitor was added and dissolved into the solution, then the solution was cooled to 0° C. then 10% w/v ammonium persulphate (APS) solution in water (4 mL) and 10% w/v tetramethyl-ethylene-diamine (TEMED) solution in water (4 mL) were added respectively under vigorous stirring. The reaction mixture was stirred for about 1 min, and then was transferred in the appropriate container and cooled at a temperature of −15° C. for 24 hours until cryogel is formed. The as-formed material was then thawed and washed with water then diluted HCl and ethanol. The material was finally dried with nitrogen flux and eventually by vacuum.

Example 5: synthesis of cryogel starting from the monomer synthesized with the procedure of examples 3 and copolymerized with a monomer not containing n-alkyl-D-glucamine (HEMA) and a crosslinker different from N,N-disubstituted-N-alkyl-D-glucammonium salt (MBAA).

To the organic phase containing N-(4-vinylbenzyl)-N-methyl-D-glucamine (VbNMG) in a mixture with N,N-bis(4-vinylbenzyl)-N-methyl-D-glucammonium chloride (50 mL) were added 2-hydroxyethyl methacrylate (HEMA) (23.3 ml) and N,N′-methylenebisacrylamide (MBAA) (8.3 g). The mixture was diluted with water (100 mL) and HCl 1.5M was added under stirring until pH was in the range 6-8 then water was added to reach a final volume of the solution of 244 m. The mixture was cooled to 0° C. then 10% w/v ammonium persulphate (APS) solution in water (3 mL) and 10% w/v tetramethyl-ethylene-diamine (TEMED) solution in water (3 mL) were added respectively under vigorous stirring. The reaction mixture was stirred for about 1 min, and then was transferred in the appropriate container and cooled at a temperature of −15° C. for 24 hours until cryogel is formed. The as-formed material was then thawed and washed with water then diluted HCl and ethanol. The material was finally dried with nitrogen flux and eventually by vacuum.

### Material Characterization

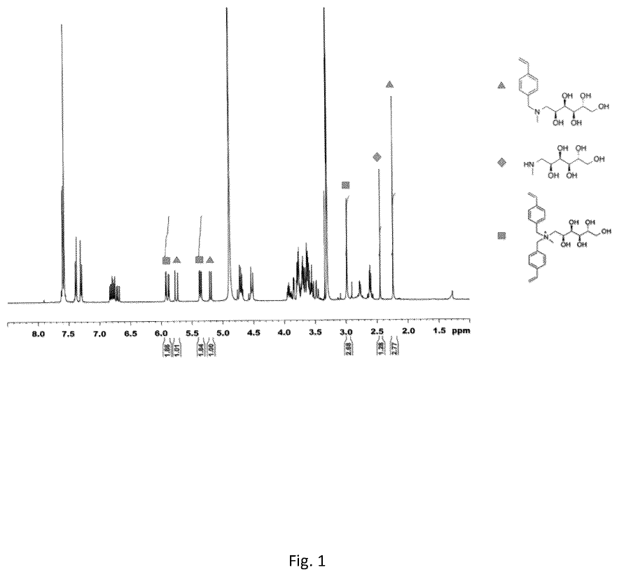

The VbNMG monomer structure was confirmed by ¹H NMR, registered by using Bruker Avance™ 400 (400.13 MHz) instrument. TMS was used as a reference. Signals in FIG. 1 belonging to the organic phase mixture obtained after 24 h. showed that the benzyl vinyl chloride completely reacted to form the monomer VbNMG and the disubstituted N,N-bis(4-vinylbenzyl)-N-methyl-D-glucamine.

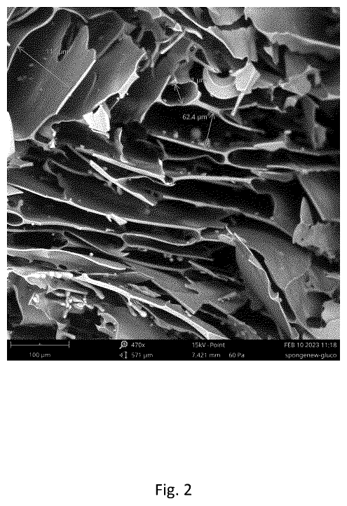

The material's morphology was investigated by scanning electron microscopy (SEM), performed using a Thermo Phenom Prox G5. The sample was previously coated with a thin layer of gold (<10 nm) to make them conductive. The micrography showed a macroporous structure of the material with pores diameter ranging from 30 to 120 micrometers, (FIG. 2).

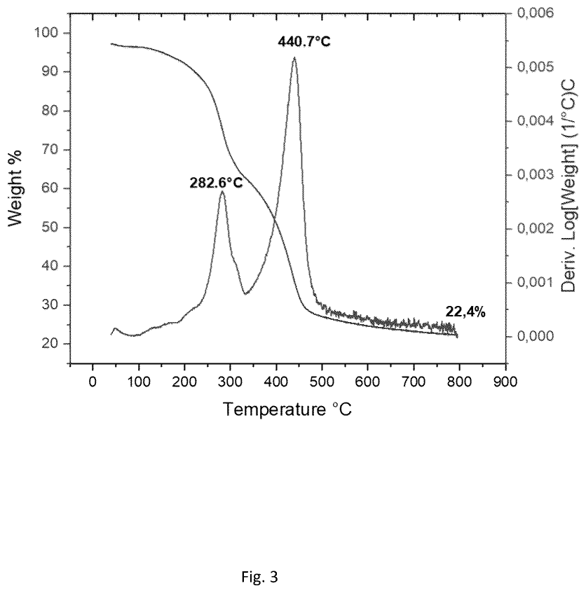

The sample was subjected to thermogravimetric analyses (TGA) by using a thermogravimetric apparatus (TA Instruments Q500) under a nitrogen atmosphere (flow rate 60 mL/min) at 10° C./min heating rate, from 40° C. to 800° C. TGA sensitivity is 0.1 μg with a weighting precision of ±0.01%. The isothermal temperature accuracy is ±1° C. FIG. 3 showed the TGA of the material. The sample undergoes two separate thermal degradation steps beginning from ~200° C. up to ~500° C.

The first thermal degradation step beginning at 200° C. with the temperature at the maximum rate of degradation (TMRD) at 282.6° C. can derive from the decomposition of glucamine chelating groups of the cryogel. At higher temperatures, the thermal degradation of the poly 4-vinyl-benzyl chains took place in the range of 412-425° C. giving a residue of around 22%.

The efficiency of synthesized cryogels for the sequestration of arsenic from the water was evaluated by preparing solutions of Na₂HAsO₄·7H₂O at pH 6.5 with initial concentrations in As (V) ions of 0.05, 7.46, and 346.5 ppm.

The adsorption tests were carried out using approximately 10 mg of sample for 5 mL of solution measuring the residual concentration of arsenic after 8 h by ICP-MS. The material can reduce concentration below the limits of potability. Precisely, the residual As(V) content after adsorption is 2 ppb for the starting solution at 0.05 ppm. ppb as shown in the following Table 1, reporting residual values of As (V) ions after water treatment measured by ICP-MS technique.

TABLE 1

| C₀ | C₈ₕ | |
|---|---|---|
| (mg L⁻¹) | (mg L⁻¹) | Retention ^{(a)} |
| 0.05 | 0.002 | 96% |
| 7.46 | 0.07 | 99% |
| 346.5 | 46.67 | 86% |

${( a )}^{} = \frac{( {C}_{0} - {C}_{e} )}{{C}_{0}} \times 100$

The efficiency of synthesized cryogels for the sequestration of chromium from the water was evaluated by preparing solutions of K₂Cr₂O₇ with initial concentrations in Cr ions of 100 ppb, 8, and 373 ppm. The material is able to reduce concentration below the limits of potability. Precisely, the residual Cr content after adsorption is 3 ppb for the starting solution at 100 ppb as shown in the following table 2, reporting residual values of Cr(VI) ions after water treatment measured by ICP-MS technique.

TABLE 2

| C₀ | C₈ₕ | |
|---|---|---|
| (mg L⁻¹) | (mg L⁻¹) | Retention ^{(a)} |
| 0.1 | 0.003 | 97% |
| 7.96 | 0.31 | 96% |
| 372.7 | 40.5 | 89% |

${( a )}^{} = \frac{( {C}_{0} - {C}_{e} )}{{C}_{0}} \times 100$

1. A macroporous polymeric adsorbent material having a three-dimensional structure comprising interconnected pores of a diameter comprised between 5 and 100 μm as measured by scanning electron microscopy (SEM),
wherein the macroporous polymeric adsorbent material comprises a plurality of A moieties and has a structure set forth in formula (I): 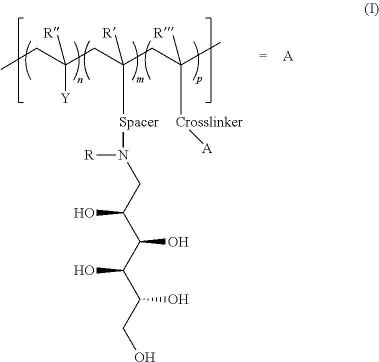
wherein n is a percentage comprised between 0 and 99;
m is a percentage comprised between 1 and 100;
n+m is 100;
p is a value ranging from 0% to 300% of (n+m):
Y is a moiety that does not contain an N-alkyl-D-glucamine and is selected from the group consisting of: COOH, CONH₂, COOCH₂CH₂OH, COOCH₂CH₂NH₂, COOCH₂CH₂N(CH₃)₂, SO₃H, alkyl and aryl residue containing a SO₃H group or a COOH group;
R is selected from the group consisting of CH₃, CH₂CH₃, CH₂CH₂CH₃, and CH(CH₃)₂;
R′, R″, R″′, the same or different are H or CH₃;
Spacer is a compound that covalently connects an N-alkyl-D-glucamine with a main polymeric chain comprised of a plurality of A moieties, and the spacer is selected from the group consisting of: 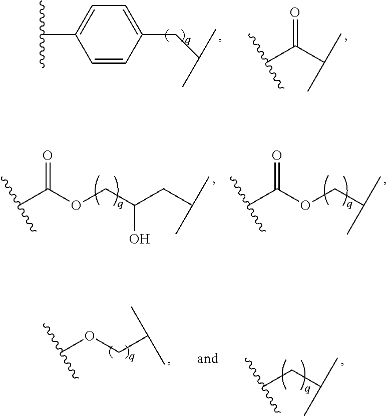
q is an integer comprised between 1 and 10; [symbol]
represents the main polymeric chain comprising the plurality of A moieties; [symbol]
represents covalent to a nitrogen of the N-alkyl-D-glucamine;
A is a moiety of the main polymeric chain, and A is repeated as indicated in formula (I); and
Crosslinker is a N,N-disubstituted-N-alkyl-D-glucammonium salt, wherein disubstituted means substituted with two polymerizable moieties, equal or different, selected from the group consisting of acrylic, methacrylic, vinylic, styrenic, and vinylbenzylic,
and alkyl means C1-C4 alkyl or a mixture of N,N-disubstituted-N-alkyl-D-glucammonium salt with another crosslinker, not being and different from N,N-disubstituted-N-alkyl-D-glucammonium salt, selected from group consisting of:
N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, and poly(propyleneglycol)diacrylate.

2. A cryogel material comprising a macroporous polymeric adsorbent material having a three-dimensional structure with interconnected pores of diameter comprised between 5 and 100 μm as measured by scanning electron microscopy (SEM), being in the form of a cryogel, wherein the cryogel comprises a main polymeric chain comprising a plurality of monomers having formula as set forth in formula (I): 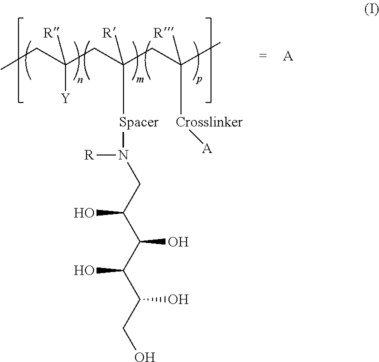
wherein n is a percentage comprised between 0 and 99;
m is a percentage comprised between 1 and 100;
n+m is 100;
p is a value ranging from 0% to 300% of (n+m);
Y is a moiety that does not contain N-alkyl-D-glucamine and is selected from the group consisting of: COOH, CONH₂, COOCH₂CH₂OH, COOCH₂CH₂NH₂, COOCH₂CH₂N(CH₃)₂, SO₃H, alkyl and aryl residue containing a SO₃H group or a COOH group;
R is selected from the group consisting of CH₃, CH₂CH₃, CH₂CH₂CH₃, and CH(CH₃)₂;
R′, R″, R″′, the same or different are H or CH₃;
Spacer is a moiety of the monomer containing N-alkyl-D-glucamine which connects a N-alkyl-D-glucamine with the main polymeric chain, and is selected from the group consisting of: 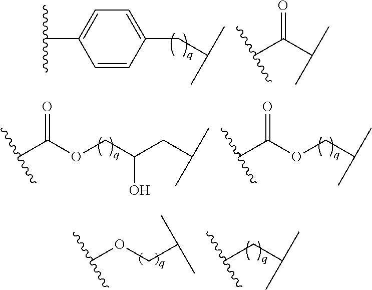
q is an integer comprised between 1 and 10; [symbol]
represents the main polymeric chain; [symbol]
represents the link with the nitrogen of N-alkyl-D-glucamine;
A is the main polymeric chain which is repeated as indicated in the general formula (I);
Crosslinker is a N,N-disubstituted-N-alkyl-D-glucammonium salt, wherein disubstituted means substituted with two polymerizable moieties, equal or different, selected from the group consisting of acrylic, methacrylic, vinylic, styrenic, and vinylbenzylic,
and alkyl means C1-C4 alkyl or a mixture of N,N-disubstituted-N-alkyl-D-glucammonium salt with another crosslinker, not being and different from N,N-disubstituted-N-alkyl-D-glucammonium salt, selected from group consisting of:
N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, and poly(propyleneglycol)diacrylate.

3. A process for the preparation of a macroporous polymeric adsorbent material of claim 1 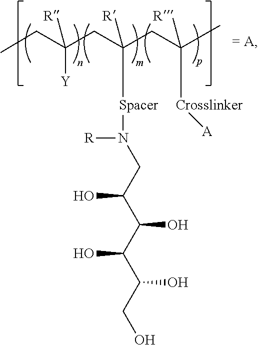
wherein the process comprises:
(a) mixing of a monomer comprising an N-substituted-N-alkyl-D-glucamine and a crosslinker comprising a N,N-disubstituted-N-alkyl-D-glucammonium salt, in water or in a water and an organic solvent being immiscible in water and having a density lower than water, to obtain a mixture of the monomer and the crosslinker,
(b) diluting the mixture of (a) in water at a pH comprised between 6-8,
(c) adding under stirring conditions comprising a temperature comprised between 0 and 5° C. an initiator of radical polymerization and a catalyst for the production of radicals to obtain a solution,
(d) maintaining the solution of (c) under conditions comprising a temperature comprised between −10 and −25° C. for a time comprised between 12 and 72 hours until the macroporous polymeric adsorbent material is obtained, and
(e) thawing and washing the macroporous polymeric adsorbent material.

4. The process of claim 3, comprising the following steps:
(a) mixing in water or in a mixture comprising water and a suitable organic solvent, immiscible with water and having a density lower than water, in the presence of a salt of carbonic acid, at a temperature comprised between 15° C. and 60° C. and for a time comprised between 2 hours and 72 hours, N-alkyl-D-glucamine with an appropriate unsaturated alkyl halide or acyl halide, for the synthesis of at least one polymerizable monomer containing N-substituted-N-alkyl-D-glucamine selected from the group consisting of: 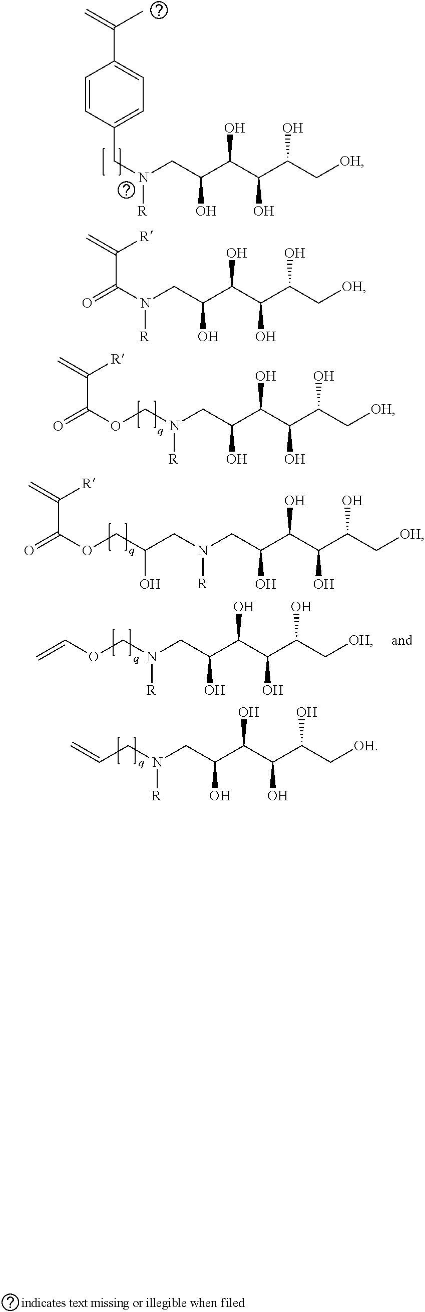
and a corresponding N,N-disubstituted-N-alkyl-D-glucammonium salt acts as a crosslinker,
wherein R is selected from the group consisting of CH₃, CH₂CH₃, CH₂CH₂CH₃, and CH(CH₃)₂,
R′ is H, CH₃;
q is an integer comprised between 1 and 10.
(b) isolating the bottom phase of the reaction mixture of the step a) obtained at the end of the reaction;
(c) diluting the bottom phase of the step b) with water and pH adjusting in an interval comprised between 6-8 under stirring at a temperature between 0 and 5° C., then a solution containing an initiator of radical polymerization and a catalyst for the production of radicals is added to obtain a mixture;
(d) Cooling of the mixture as obtained at the end of step c) at a temperature comprised between −10 and −25° C. for a time comprised between 12 and 48 hours until the cryogel is obtained; and
(e) thawing and washing the cryogel.

5. A process of claim 4, wherein after step b) and before steps c) a further step c′) is added wherein in step c′) to the bottom phase, as obtained at the step b), a monomer that not contains N-substituted-N-alkyl-D-glucamine and/or a crosslinker not being and different from N,N-disubstituted-N-alkyl-D-glucammonium salt are added.

5. A process of claim 5 wherein the monomer not containing N-substituted-N-alkyl-D-glucamine is selected from the group consisting of:

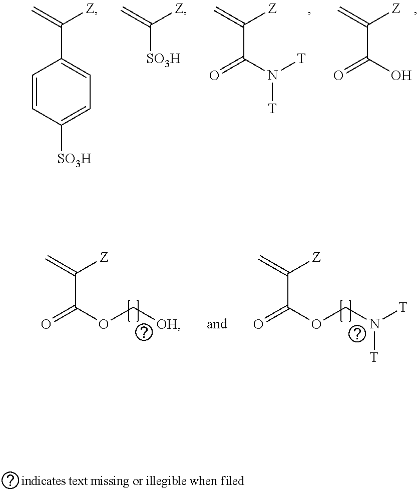

5. The process of claim 5 wherein the crosslinker not being and different from N,N-disubstituted-N-alkyl-D-glucammonium salt is selected from group consisting of: N,N′-Methylenebisacrylamide, N,N′-Methylenebismetaacrylamide, N,N′-hexamethylenebisacrylamide, N,N′-diallylbisacrylamide, diallyl fumarate, diallyl phthalate, ethyleneglycoldiacrylate, poly(ethyleneglycol)diacrylate, propyleneglycoldiacrylate, poly(propyleneglycol)diacrylate.

8-10. (canceled)

11. A cryogel made by a process comprising:
(a) mixing a monomer comprising an N-substituted-N-alkyl-D-glucamine and a crosslinker comprising a N,N-disubstituted-N-alkyl-D-glucammonium salt, in water or in a water and an organic solvent being immiscible in water and having a density lower than water, to obtain a mixture of the monomer and the crosslinker,
(b) diluting the mixture of (a) in water at a pH comprised between 6-8,
(c) adding under stirring conditions comprising a temperature comprised between 0 and 5° C. an initiator of radical polymerization and a catalyst for the production of radicals to obtain a solution, and
(d) maintaining the solution of (c) under conditions comprising a temperature comprised between −10 and −25° C. for a time comprised between 12 and 72 hours until the cryogel is obtained.

12. The process of claim 3, wherein adding before the addition of the of the initiator of radical polymerization and the catalyst for the production of radicals, a monomer not containing N-alkyl-D-glucamine and/or a crosslinker not being and different from N,N-disubstituted-N-alkyl-D-glucammonium salt.

13. The cryogel of claim 11, wherein the process comprises adding before the addition of the of the initiator of radical polymerization and the catalyst for the production of radicals, a monomer not containing N-alkyl-D-glucamine and/or a crosslinker not being and different from N,N-disubstituted-N-alkyl-D-glucammonium salt.
